(19) United States
(12) Patent Application Publication
(10) Pub. No.: US 2008/0164689 A1
(43) Pub. Date: Jul. 10, 2008

(54) Multimodal Security Feature For Counterfeit Detection of Banknotes and Security Documents

(75) Inventors: Frederic Jordan, Les Paccots (CH); Martin Kutter, Remaufens (CH); Nicolas Rudaz, Veyras (CH)

Correspondence Address: DLA PIPER US LLP;ATTN: PATENT GROUP, 500 8th Street, NW, WASHINGTON, DC, 20004-2131, US

(73) Assignee: ALPVISION SA, Vevey (CH)

(21) Appl. No.: 11/908,230

(22) PCT Filed: Mar. 15, 2006
(86) PCT No.: PCT/IB06/50809

§ 371 Date: Sep. 10, 2007

Related U.S. Application Data
(60) Provisional application No. 60/662,077, filed on Mar. 16, 2005.

(51) Int. Cl. G07D 7/08

(52) U.S. Cl. 283/74

(57) ABSTRACT

The present invention aims to provide a simple and reliable security element into a document, which can be recognized without special equipment. This aim is achieved with a paper or paper-like document with a surface, the surface being provided at least in a partial area with a background layer, wherein at least part of the surface of the document is provided with a security element comprising a series of protuberant structures spaced at regular interval. The protuberant structure creates a relief than can be easily recognized while rubbing the document. Contrarily to watermarks or other stamps, the fact that the structure is spaced at regular interval allows the user to better detect it over random structures. Regular interval does not mean that the space between each protuberant structure is equal. Regular means that each structure has a similar width and each space between the structures has also a similar width.

### STATE OF THE ART

Fraud against counterfeiting is a constant threat against the monetary value of many security documents, in particular banknotes. Banknotes typically include many security features which create cumulative security layers protecting against counterfeiting and tampering. The general trend is such that the number of security features—particularly visual features—is constantly increasing. Often new features are added without laying down the old ones (such as guilloches and Lissajous). Moreover, new features usually require some level of expertise in order to be recognized and validated (like the color shift effect of an Optically Variable Ink). To some extent, this inflation of visual security features misleads the user and produces an effect opposite to the one sought.

The main challenge faced by new security features is to be at the same time easy to detect and difficult to duplicate.

The current invention offers a new approach for these two problems. Production of the new security feature is like for a standard optical feature but detection is based on acoustic feature properties.

It is generally accepted that there are 3 different classes of anti-counterfeiting solutions: detectable without any additional device (such as holograms and watermarks), detectable with a simple device (such as UV lamp) or with a complex device (such as devices to perform chemical analysis of special color pigments). Most of first and second level counterfeit detection methods rely on optical features, meaning that there are visible to the naked eye or when inspected by using a simple device. Examples include iridescent ink, optically variable ink, holograms, ultraviolet inks, infrared inks, and microtext. As mentioned above, the described invention belongs to the group of non visual features. This group also includes the fiduciary paper, which, through its special composition, gives a recognizable tactile feeling when touched and a recognizable noise when wrinkled (high amount of cotton is used for that purpose). Another non visual feature is intaglio print which has a sufficient thickness so that it can be felt with fingers. Compared to the former non visual features, the current invention provides the intuitiveness of the paper feeling (which has the drawback of a low security) with the security of intaglio (which has the drawback of requiring some level of expertise in order to be able to feel the structure with fingers). Moreover, when the new feature is printed with a transparent ink, such as varnish, it does not alter the banknote design.

### SHORT DESCRIPTION OF THE INVENTION

The present invention aims to provide a simple and reliable security element into a document which can be recognized without special equipment.

This aim is achieved with a paper or paper-like document with a surface, the surface being provided at least in a partial area with a background layer, wherein at least part of the surface of the document is provided with a security element comprising a series of protuberant structures spaced at regular interval.

The protuberant structure creates a relief than can be easily recognized while rubbing the document. Contrarily to watermarks or other stamps, the fact that the structure is spaced at regular interval allows the user to better detect it over random structures. Regular interval does not mean that the space between each protuberant structure is equal. Regular means that each structure has a similar width and each space between the structures has also a similar width. It will be shown to the attached drawings that one can define transitional region where the structure and/or the space is completely different. This is the case when two frequencies are generated while rubbing the surface.

### SHORT DESCRIPTION OF THE FIGURES

The invention will be better understood thanks to the attached Figures in which:

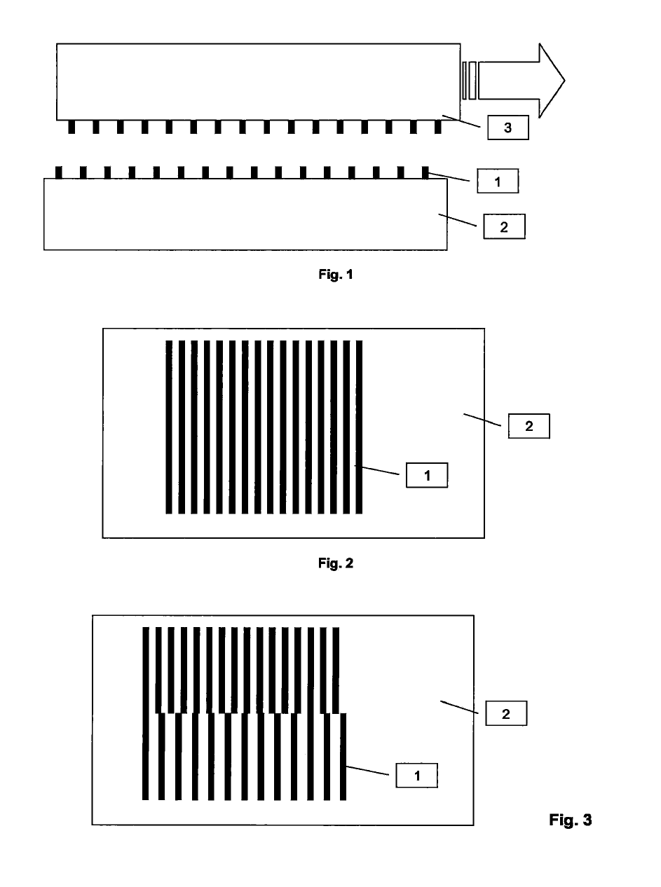

the FIG. 1 shows a pattern on the substrate and how an activator pattern is rubbed against the pattern on the substrate to create the sound,

the FIG. 2 shows a simple pattern which generates one main frequency when rubbed,

the FIG. 3 shows how two stripe patterns can be used in order to create a chord,

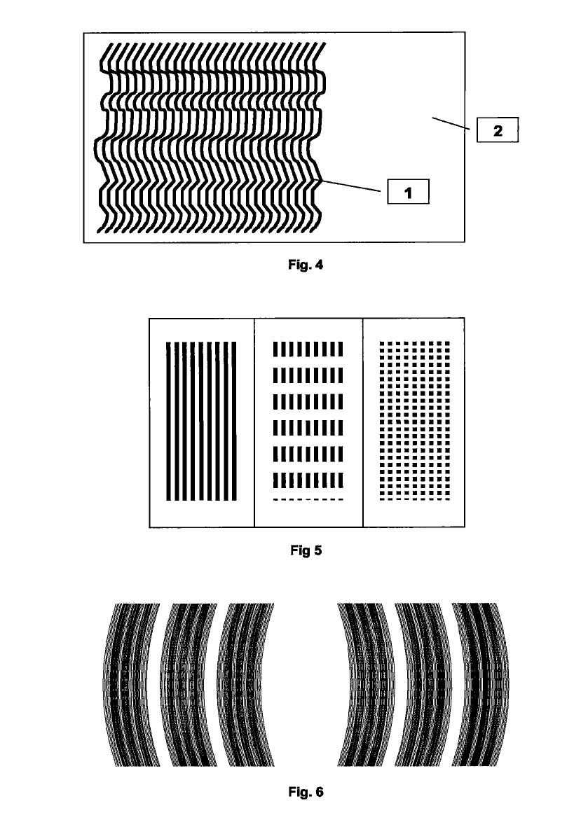

the FIG. 4 shows a base structure consisting of curves,

the FIG. 5 shows three different types of activator patterns, solid lines, dashed lines, and dotted lines. The two types on the right are easier to use since their sensitivity to the rubbing direction is decreased,

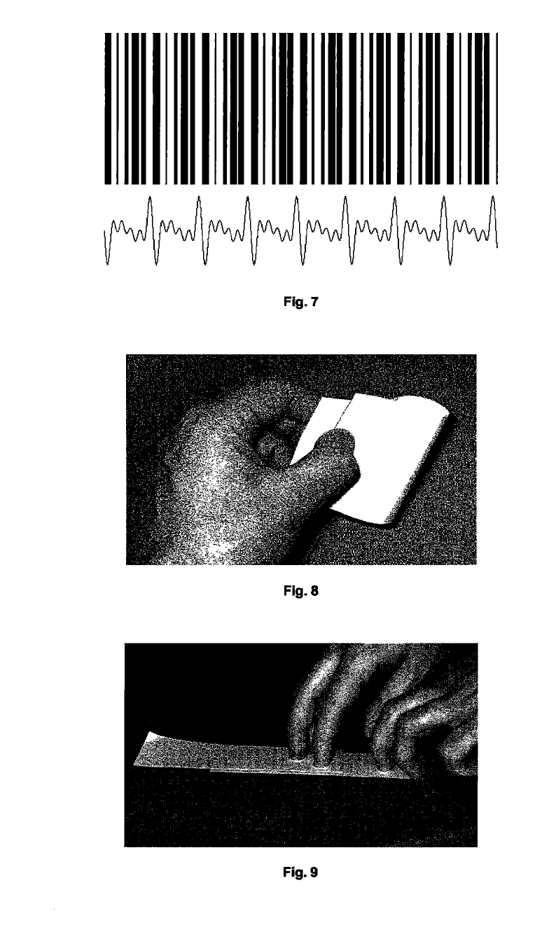

the FIG. 6 shows parallel lines with a curvature that lowers sensitivity to rubbing direction. The design also illustrates the encoding of several frequencies.

the FIG. 7 shows a wave signal made up of 4 different frequencies (bottom) and the corresponding pattern,

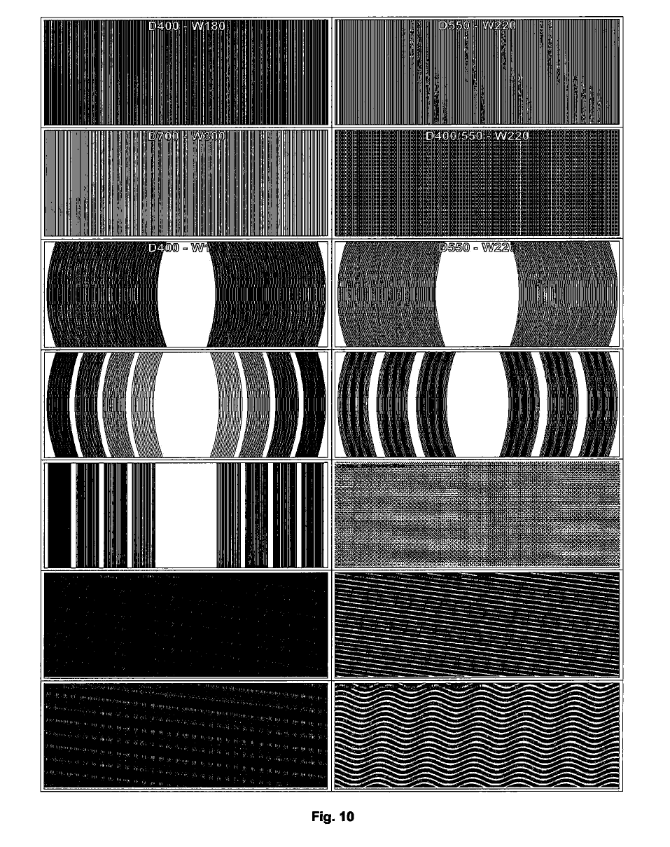

the FIG. 8 shows one way to rub the surface, by folding it up again and rubbing it onto itself.

the FIG. 9 shows another approach using two different samples

the FIG. 10 shows the various shapes of the structure.

### DETAILED DESCRIPTION

The concept of the invention is to put a structure, called base structure, (FIG. 1, item 2) on the surface of a security document (FIG. 1, item 1) which creates a recognizable sound when rubbed or a particular sensation when rubbed.

By “document” it is meant any security document such as banknotes, certificates, shares, contracts, passports, made in paper of paper-like material (cotton, fiber, silk, polymer etc). There exists different means to create the structure and transfer it on the document surface. There are also various ways to rub it in order to generate the noise.

### Structure Creation

In the simplest approach, the base structure is made out of thin lines (FIG. 1 and FIG. 2) which are equally spaced. When applied to the surface, the lines must be such that they form small hills. If the lines were flat, for example when printed with an inkjet printer on standard paper, then generation of a sound would not be possible. The mentioned line structure is then rubbed with a second surface, this second surface is called activator. The activator can have the same properties as the base structure, or be very different. In any case, during the rubbing process, the desired effect of creating a sound will be generated. In the particular case where the activator has the same parallel line structure as the base structure, it is possible to predict the tone of the sound produced. For computing the tone, the line thickness, their spacing and the rubbing speed has to be considered. For instance, if the lines have a width of 0.5 mm and are spaced by the same distance and the rubbing speed is of 10 cm per second, the generated sound will mainly consist of a tone with a frequency centered around 100 Hz. This is an audible frequency. The amplitude of the tone depends on various; parameters, including the pressure applied during rubbing, the thickness and height of the lines, as well as the acoustical characteristics of the two rubbed materials. More sophisticated sounds can be produced using variable spacing between lines. It is also possible to produce chords using different series of regular structures, each based on a different line spacing (See FIG. 3) or combination of different frequencies on the same pattern (see FIG. 6 and FIG. 10). The following equation provides one example of frequency combination:

f(x)=sin(x)+sin(2x) and C(x)=0 if f(x)<0, C(x)=1 if f(x)>=0

where x is the position along the x direction on the structure and C(x) is the color of the structure (0 for white and 1 for black).

It is then potentially possible to produce any kind of sound by combining variable spaced stripes and parallel stripes with different frequencies. The generation of the stripes for a given sound can be performed automatically using a software application. The pattern can be created in such a way that it can be played “backward”, or partly, while still featuring a recognizable sound.

In addition to parallel straight line structures, the base structure and activator can also consists of non straight line elements, such as curved and jagged lines. This approach is shown in FIG. 1. The lines may be curved, jagged, or even have interruptions. The advantage of using non straight lines is the possibility to create a visually pleasing structure which may also seamlessly integrate with the design of the document.

For the activator, it is also possible to use elements which have interrupted lines. Examples of this are shown in FIG. 5. The advantage here is the fact that the sound generation is much less sensitive to the rubbing direction. Another approach that decreases the sensitivity to rubbing direction is also shown in FIG. 6. Many other variations are possible as shown in FIG. 10

### Structure Transfer

The structure should have some thickness in order to produce an audible sound. Moreover, the resolution of the pattern should be sufficiently accurate to produce the expected sound effect. In practice, a position accuracy of 500 micrometers and a thickness of at least 10 micrometers is desirable, although other arrangements are also possible. Many technologies are suitable for transferring the structures onto the surface: several printing technologies, molding, laser abrasion, laser perforation and embossing can be used for this purpose. Printing technologies that are especially interesting are those which enable to deposit a substantial amount of ink on the surface. For instance, intaglio or silk screening technologies are both suitable for this purpose. Color laser printers are also appropriate. In order to increase the visual impact of the structure on the design, it is also possible to apply it in a transparent manner, for example by using some varnish (for instance UV dried varnishes or solvent based varnishes may be used). In the particular case where the activator and the base structure are both printed with varnish, better results are obtained when they freely slip on each other (for instance, some matte varnishes provide less resistance to rubbing than glossy varnishes). Any material on which the structure can be deposit or engraved can potentially be used. For applications in the field of security documents (and banknotes in particular), paper and polymer can be used. Digital transfer technologies like laser engraving or digital printing enable structure generation on-the-fly for each marked document. This provides means for document personalization with a different embedded sound on each sample.

In a particular embodiment, the document having a rectangular shape, comprises the security structures at its two extremities and leaving the center of the document without security element. This has the advantage that the person manipulating the document can detect the modification of the surface and thus recognize genuine documents.

In one embodiment of the invention the applied structure can be made out of micro tubes or other hollow, or partly hollow, structures. Such structures may then have the effect of a physical audio amplifier and increase the loudness of the produced sound.

### Rubbing Methods

In the simplest embodiment set forth above, two identical structures consisting of parallel and equally spaced lines are rubbed together (FIG. 1, item 3). Using this arrangement, it is extremely important to rub the two pieces of paper perpendicularly to the line structure. If this is not the case, no sound will be produced. As outlined above it is also possible to use two different structures for the base structure and the activator. The rubbed materials can either be two separate pieces (FIG. 10) or one single piece (FIG. 8) which is folded up again and rubbed onto itself (in the latter case the base structure and the activator may be symmetrical like in FIG. 6 or FIG. 10 in respect of the folding axis in order to match together). This enables for instance to produce a sound by holding a paper between the thumb and another finger.

The activator may also be made of anything which can vibrate and produce an audible effect. For instance, the structure can be rubbed with a nail, a plectrum, the corner of a piece of paper or any other device.

### Other Methods

The structure can also be felt with the fingers and provide a unique and typical touch. This particular feeling can be even increased by an appropriate choice of the structure. For instance, a structure featuring a large uniform area increases the contrast with the structured areas (like the central part in FIG. 6).

Another positive effect of the transparent structure on the document is the generation of a moiré effect when applying a transparent layer on the document on which is printed the same structure either in black, varnish or other color. The matching of the transparent structure on the document and the same structure on a transparent layer (or filter) produces a moiré effect perpendicular to the structure (or lines) direction. Moreover, the moiré pattern moves perpendicularly to the motion of the transparent layer on the document. With a simple transparent, it is then possible to achieve a a counterfeit detection with a second security level. In fact, to produce this effect, the user should slightly move the transparent layer over the document. This move entails the generation of moiré.

Because several methods can be used to identify the feature, the invention is defined as a “multi-modal” security feature.

The current invention is particularly challenging to counterfeit for at least two reasons:
As a whole, copy machines and home/office printers cannot produce transparent relief structures. Counterfeiting would therefore require the use of an industrial printing equipment or alternative method in order to shape the paper surface.
The structure is a complex pattern, which is even harder to duplicate since it is printed with a transparent color that is difficult to digitize with standard digital scanners.

1. A paper or paper-like document comprising:
a surface;
a background layer provided at least in a partial area of the surface
wherein at least part of the surface is provided with a security element comprising a series of protuberant structures spaced at regular intervals.

2. The paper or paper-like document of claim 1, wherein the series of protuberant structures includes a set of spaced straight, curved or jagged lines with or without interruptions.

3. The paper or paper-like document of claim 1, wherein the structures are printed.

4. The paper or paper-like document of claim 3, wherein the structures are printed in Intaglio.

5. The paper or paper-like document of claim 3, wherein the structures are printed in silk screening.

6. The paper or paper-like document of claim 3, wherein a varnish ink is used for printing.

7. The paper or paper-like document of claim 1, wherein the structure is embossed into the document.

8. The paper or paper-like document of claim 1, wherein the structure is engraved into the document.

9. The paper or paper-like document of claim 1, wherein the structure is formed by depositing a plastic or metallic film on the surface

10. The paper or paper-like document of claim 1, wherein the structure takes the form of a woven fabric.

11. The paper or paper-like document of claim 1, wherein part of the surface comprises no structure.

12. The paper or paper-like document of claim 1, wherein the document has a rectangular shape with two extremities, the two extremities being covered by the structures and the center part having no structure provided thereon.
